(19) United States
(12) Patent Application Publication
(10) Pub. No.: US 2007/0196680 A1
(43) Pub. Date: Aug. 23, 2007

(54) System and method of applying architectural coatings and apparatus therefor

(76) Inventor: Harry M. Fine, Manchester, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/704,761

(22) Filed: Feb. 8, 2007

Related U.S. Application Data
(60) Provisional application No. 60/771,942, filed on Feb. 8, 2006.

(51) Int. Cl. B32B 27/42; B05D 3/02; B05D 1/02

(52) U.S. Cl. 428/524; 427/421.1; 427/372.2

(57) ABSTRACT

A coating on an architectural building material is formed by particles of a polymer that are softened using heat and allowed to cool over the surface of the building material to form a cohesive and adhesive structure or film on the building material. The polymeric coating composition is substantially free of any volatile organic compound (VOC). A system for applying coatings on architectural building materials includes an apparatus for spraying a polymer emulsion on a building material, an apparatus for removing a carrier from the polymer emulsion, and an apparatus for conveying the building material from the spray apparatus to the apparatus for removing the carrier. A method of coating an architectural building material includes spraying a substantially VOC-free emulsion having particles of a polymer onto the building material. A volatile portion of the emulsion is flashed off. Heat is then used to coalesce the particles of the polymer.

### CROSS REFERENCE TO RELATED APPLICATION

This application claims priority to U.S. Provisional Patent Application No. 60/771,942 entitled “System and Method of Applying Architectural Coatings and Apparatus Therefor” filed on Feb. 8, 2006, the contents of which are herein incorporated by reference in their entirety.

### TECHNICAL FIELD

The present invention is directed to coatings for building materials and, more particularly, to architectural coatings and systems and methods of applying architectural coatings to building materials.

### BACKGROUND OF THE PRESENT INVENTION

Concerns for both the environment and worker health and safety have prompted almost every industry to explore novel and innovative technologies to reduce or eliminate volatile organic compounds (VOC) from their applications. Volatile organic compounds are organic chemicals that have sufficient vapor pressures under ambient conditions to significantly vaporize and enter the atmosphere. Common sources of VOC include compounds such as those used in dry cleaning and other cleaning processes, in painting and staining applications, and in the processing and use of materials for construction. Other sources of VOC can be found in the processing, dispensing, and use of petroleum fuels.

Although the specific definition can vary, a VOC is generally taken to be any compound of carbon with the exception of carbon monoxide, carbon dioxide, carbonic acid, metal carbides, metal carbonates, and certain other carbon-containing compounds that have no or negligible photoreactivity under ambient atmospheric conditions. Some VOC having more than negligible photoreactivity react with nitrogen dioxides in the air to form ozone, which has been deemed to pose a health threat by causing or exacerbating respiratory problems. Some VOC emitted from paints, plastics, coatings, carpets, and other building materials can pose a threat to persons in an indoor environment. Indoor VOC emission is often considered to be a factor in “sick building syndrome.”

Coatings are often applied to architectural building materials to enhance the appearance or function of the materials. Architectural building materials include, but are not limited to, trims, moldings, cabinetry, flooring, and the like. Once applied, the coatings on the building materials must be sufficiently hard to resist physical forces (e.g., scuffing) and at least some chemical forces (e.g., weathering). However, the coatings must also be sufficiently soft to allow the material of the coating to form a continuous film over the surfaces that are to be enhanced. These coatings may be either water- or solvent-based, and VOC can be emitted from either.

Some coating compositions incorporate coalescing agents that enable the composition to form a continuous film. Such coalescing agents are typically VOC-containing materials that, upon evaporation, provide the continuous film having desirable hardness properties.

In efforts to reduce VOC emissions, however, binders have been used that incorporate polymers having crosslinkable functional groups (e.g., acetoacetates). While such binders often produce little or no VOC emissions, they typically cause the final film to be slow in curing. They also produce final films having inferior hardness properties.

What is needed is a system and method of applying coatings to architectural building materials, such coatings having little or no VOC emissions but that exhibit suitable and desirable properties relating to curing and hardness.

### SUMMARY OF THE PRESENT INVENTION

Architectural coatings are generally chemical compositions that are applied to architectural building materials (e.g., trim, moldings, siding, cabinetry, flooring, and the like). These compositions serve various functions that include, but are not limited to, cosmetic, UV protection, water proofing, fungal resistance, and the like. The coatings are generally termed paints or stains. The materials of the chemical compositions include polymer emulsions. Emulsion particles adhere to each other and to the building material to form cohesive and adhesive films. Following application of the architectural coating, a processing step takes place that entails passing the coated building materials through an oven to cure the coating and possibly to remove water entrained in the coating.

In one aspect, the present invention is directed to a coating on an architectural building material. The coating is formed by particles of a polymer that are softened or made pliable using heat and allowed to cool over the surface of the building material to form a cohesive and adhesive structure or film on the building material. The polymeric coating composition is substantially free of any volatile organic compound (VOC).

In another aspect, the present invention is directed to a system for applying coatings on architectural building materials. Such a system includes an apparatus for spraying a polymer emulsion on a building material, an apparatus for removing a carrier from the polymer emulsion, and an apparatus for conveying the building material from the spray apparatus to the apparatus for removing the carrier. The polymer is substantially free of VOC.

In yet another aspect, the present invention is directed to a method of coating an architectural building material. In the method, an emulsion having particles of a polymer is sprayed onto the building material. The emulsion is substantially free of VOC. At least a portion of the emulsion is removed by flashing off a volatile component thereof. Heat is then used to coalesce the particles of the polymer on the building material.

One advantage of the present invention is that coatings can be applied to architectural building materials without the use of coalescing agents. The function of the coalescing agent is replaced with heat. Because coalescing agents (which generally include VOC-containing materials) are not used in the present invention, there is no emission of VOC from the coalescing agent into the atmosphere. By eliminating (or at least substantially reducing) VOC emissions, health risks to workers are minimized and environmental concerns are abated.

### BRIEF DESCRIPTION OF THE DRAWINGS

FIG. 1 is a schematic representation of a system for applying coatings to building materials.

FIG. 2 is a schematic representation of a coating station of the system of FIG. 1.

### DETAILED DESCRIPTION OF THE PREFERRED EMBODIMENTS

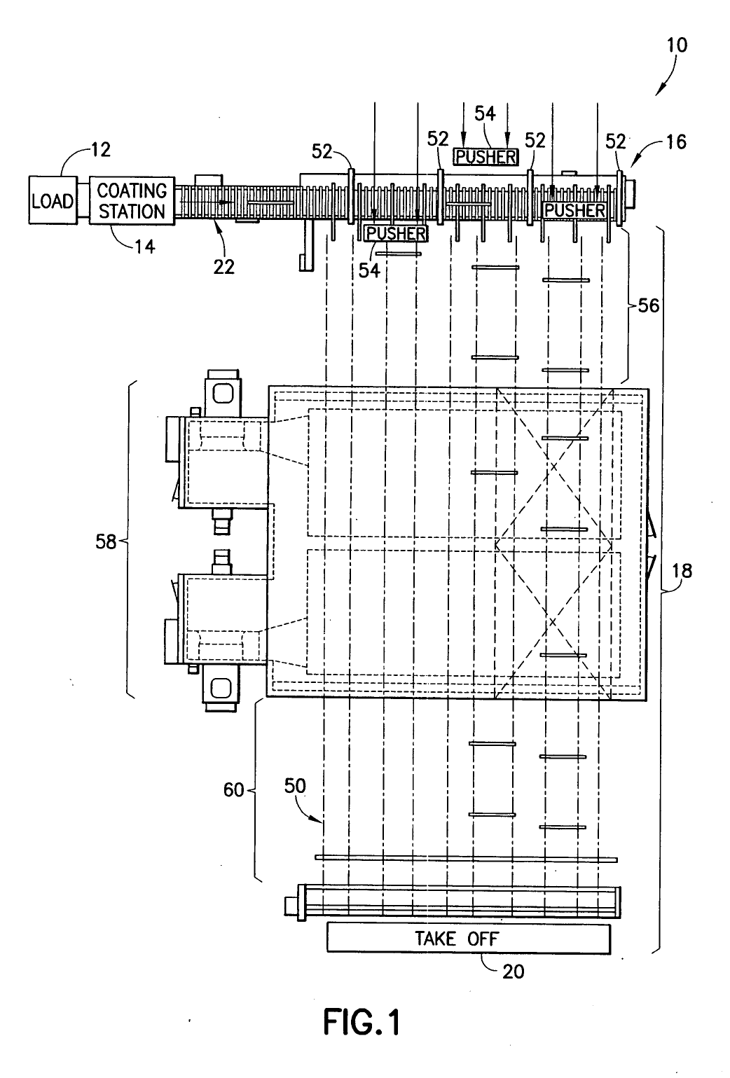

Referring to FIG. 1, a system for applying coatings to building materials is shown generally at 10 and is hereinafter referred to as “system 10.” System 10 comprises a feed station 12, a coating station 14, a transfer station 16, an oven or drying station 18, and a take off station 20. The building materials are typically boards having linear dimensions that are substantially greater than either or both of the width dimensions and height dimensions thereof, although other types of building materials such as sheet rock are within the scope of the present invention. Although the building materials discussed herein are generally referred to as “boards” and are presumed to be wood such as trim molding pieces, it should be understood that other types of building materials are also within the scope of the present invention. Typical building materials within the scope of the present invention include, but are not limited to, cellulose materials such as hardwood, softwood, engineered wood, plywood, fiberboard (e.g., medium density fiberboard (MDF)), particle board, cardboard, and paper; gypsum; plaster; plastic; foam material such as open-cell foam and closed-cell foam; metal; and ceramic.

In the operation of the system 10, boards are moved from the feed station 12 to the coating station 14. The feed station 12 includes a designated area in which the boards are placed, dropped, loaded, or otherwise transferred to a coating conveyor for subsequent transfer to the coating station 14. The boards are transferred to the coating conveyor individually or in bulk by hand or by machine and are placed onto the coating conveyor in such a manner so as to facilitate their sufficient coating in the coating station 14.

The coating conveyor, shown generally at 22 and extending from the feed station 12 through the coating station 14 and to the transfer station 16, comprises a series of rollers. At least a select few of the rollers are driven, for example using at least one electric motor, to allow the boards placed on the rollers of the coating conveyor to travel through the coating station 14 to the transfer station 16. The electric motor is controllable (e.g., using a clutch and gearbox, a variable frequency drive, or the like) to allow the speed of travel along the rollers to be adjusted depending on the desired coating. In one exemplary embodiment, a motor having about one horsepower and having a variable speed control is capable of passing boards along the coating conveyor at speeds of up to about 300 feet per minute (fpm). Although the coating conveyor of the present invention is described as having driven rollers, the present invention is not limited in this regard as other configurations (e.g., wheels, belts, adjacently-positioned loops cross-connected with linking members or other mechanisms on which boards may be supported) are within the scope of the present invention.

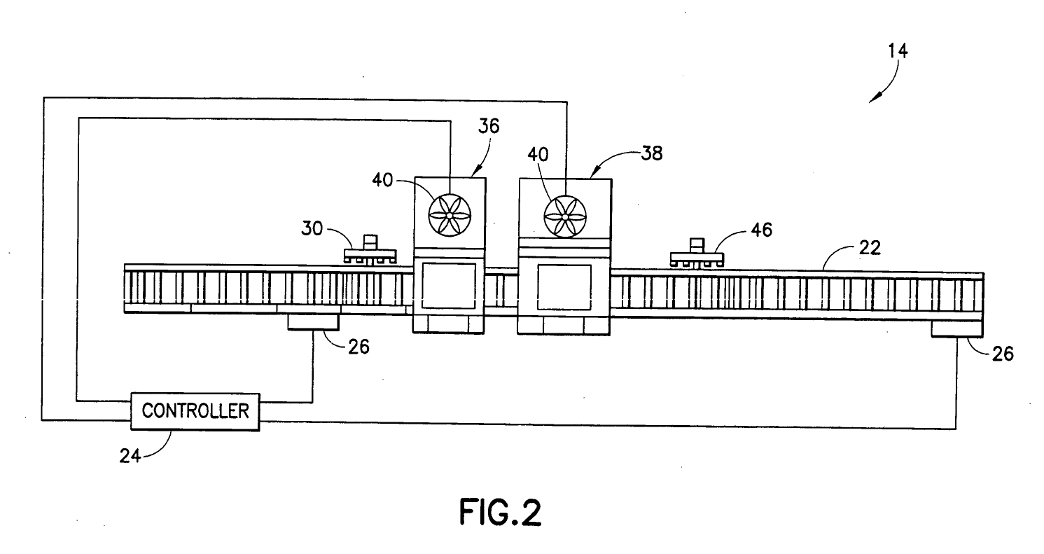

Referring now to FIG. 2, the coating station 14 includes a spray apparatus that applies the coating to at least one of the exterior surfaces of the board. The coating sprayed onto the boards is a water-based polymer emulsion that forms a film and functions as a primer when dried. Also shown in FIG. 2 is a controller 24 used to provide suitable control signals to motors 26 that drive the rollers of the coating conveyor 22 and a board detector 30 located along the coating conveyor 22. The controller 24 provides closed-loop control to the coating conveyor 22 by adjusting a rate of coating spray based on one or more input parameters such as the roller (board) speed and detection of the board by the board detector 30.

The coating station 14 further includes a first canopy 36 and a second canopy 38, both of which are positioned over the coating conveyor 22 and both of which include spray guns that are articulably mounted to enable the spray to be directed as needed. As a board moving along the coating conveyor 22 is detected by the board detector 30, the controller 24 is signaled to trigger the spray guns in the first canopy 36. Signals based on the detection of the board and its speed likewise trigger spray guns in the second canopy 38. In each canopy, overspray is collected in trays and transferred to a tank for subsequent reapplication through the guns. Airborne sprayed particles are removed using exhaust fans 40 and passed through filter(s), although the present invention is not limited in this regard as other means of removing the particles may be used.

In the first canopy 36, at least two guns are arranged to spray upward to coat the bottoms of the boards. The rollers at the entrance and exit of the first canopy 36 are preferably knife-edge rollers manufactured from an ultra-high molecular weight polymer to facilitate the leveling of the material sprayed on the bottoms as the boards exit the first canopy. In the second canopy 38, at least two guns are arranged to spray downward to coat the tops of the boards, and at least one gun is arranged to spray each side of the boards. Guns may also be positioned to spray the ends of the boards as they enter and exit the second canopy 38. As with the first canopy 36, the rollers at the entrance and exit of the second canopy 38 are preferably knife-edge rollers manufactured from an ultra-high molecular weight polymer to facilitate the leveling of the material sprayed on the bottoms of the boards as the boards exit. One or more rollers at the exit of the second canopy 38 may be driven separately from the other rollers. A second board detector 46 may be located at the exit of the second canopy 38 to provide appropriate feedback to the controller 24. The guns and the controls therefor may be provided by any suitable supplier. In the present invention, the controls are provided by Allen-Bradley, which is a division of Rockwell Automation of Milwaukee, Wis.

Referring back to FIG. 1, as the sprayed boards exit the second canopy of the coating station 14 the boards move along the coating conveyor 22 to the transfer station 16. The rollers at the exit of the coating station 14 operate faster than the rollers feeding the coating station, thereby creating a longer time interval between the boards fed to the transfer station 16.

The transfer station 16 may provide a shift in direction to the boards to transfer them to an oven conveyor 50 for subsequent passage into the drying station 18. The shift in direction may be ninety degrees. In order to stop the movement of the boards on the coating conveyor 22, at least one movable end stop 52 having a photo detector extends into the path of the moving board and blocks the forward movement of the board. Additional movable end stops 52 may also be used to stop moving boards at selected locations along the coating conveyor, particularly in operations in which the boards are short and two or more boards can be accommodated widthwise through the drying station 18. The movable end stops 52 include sensors that are activated upon being impacted by the boards. To effect a shift in direction (e.g., the ninety degree shift), the sensors in the movable end stops impacted by the boards actuate pushers 54 that are laterally extendable across the coating conveyor 22 to push the boards into the drying station 18.

In the drying station 18, the oven conveyor 50 carries the boards. The oven conveyor 50 comprises a belt wide enough to accommodate two boards laid widthwise thereon. The belt is a series of roller chains driven by a variable speed sprocket arrangement. In one exemplary embodiment, the oven conveyor 50 moves the boards from a flash off zone 56 of the drying station 18, into a heating zone 58, and through a cool down zone 60. The oven conveyor 50 moves the boards through the drying station 18 at a speed of about 5 feet per minute (FPM). The heating in the drying station is maintained at about 150 degrees F. to about 160 degrees F. Most materials associated with lumber (e.g., glues used in manufactured lumber) are capable of tolerating temperatures in this range. The present invention is not limited in regard to the foregoing speeds and temperatures, however, as other rates based on the type of spray coating applied and operating parameters of the drying station 18 (e.g., temperature, exhaust capabilities, and the like) are within the scope of the invention.

The heating zone 58 is constructed of panels that, except for openings through which the boards are fed and removed, substantially enclose the heating area. Non-settling mineral wool insulation is mounted on the panels, which are preferably of tongue-and-groove configuration. Such a configuration minimizes the heat transfer through the panels. Preferably, all joints between the panels are packed with insulation.

After the boards are transferred from the transfer station 16 to the oven conveyor 50, the speed of the oven conveyor is controlled to allow for adequate flash off of volatile components of the sprayed material in the flash off zone 56. As used herein, the term “flash off” indicates the removal of at least a portion of a liquid by quickly converting the liquid to vapor in such a way that the vapor is in equilibrium with the liquid. Exhaust fans remove the flashed off vapors and direct them through ducts to a filter.

After the flash off zone 56, the boards enter the beating zone 58. The heating zone 58 is a convection oven through which forced hot air (about 110 degrees Fahrenheit (F) to about 180 degrees F.) is circulated. Within the heating zone 58, separate insulated enclosures may include at least one centrifugal recirculation fan, a burner assembly, and a fresh air inlet. Supply ducts include air nozzles for directing air perpendicularly from inlets of the supply ducts to the boards as they travel on the oven conveyor 50. The ducts may be fabricated from any suitable material, such as aluminized steel, and may be reinforced as needed to reduce vibration. At least two fans provide for the circulation of air through the oven, and at least one fan provides for oven exhaust. Hinged doors allow access to the belt from outside the oven. Preferably, the heat source for the oven is a line-type gas burner in which fuel and air are mixed at an outlet nozzle. The burner has a prefabricated valve train.

Throughout the flash off zone 56 and the heating zone 58, the polymer coalesces into a film that, when cured, forms a soft crack-resistant coating.

Upon the boards moving from the heating zone 58 to the cool down zone 60, the heat from the boards is dissipated. The boards are then removed from the oven conveyor 50 either automatically or manually and either stored, packed, shipped, or further processed.

Control of the entire system 10 is effected via a control panel 70 that is in communication with the controller 24 (FIG. 2). The control panel 70, which may be integral with the controller 24 or located remotely therefrom, includes a disconnect switch with a door interlock handle and a control voltage transformer. A current proportioning, digital indicating temperature controller with a modulating motor for proportional control of the burner main gas valve is also provided. The control panel 70 also includes magnetic motor starters and electrical safety systems to meet all applicable regulatory standards. A separate high limit temperature control having a manual reset capability is included to monitor the temperature in the oven. A warning alarm indicates a shut-down condition in the oven.

The control of the system 10 is based at least in part on the coating and drying of the films on the boards. More specifically, the feed rates and temperatures are adjusted based on the materials of the boards, the desired coating (as well as its thickness and tack qualities), as well as other factors. Accordingly, the speeds of the coating conveyor 22 and the oven conveyor 50, the rates of feeds to the spray guns, and the heat supplied to the heating zone 58 are controlled to give the optimum dwell times within the various zones.

The film formation on the boards is effected via thermal energy. In other words, the function of the coalescing agent is replaced with heat. More specifically, the formation of the film on the surface of the board is facilitated using heat to soften the polymer emulsion particles from an initial rigid state into a pliable state. In the pliable state, the particles coalesce over the surface of the board. Upon cooling, the coalesced particles bond to form the film. Because no coalescing agent is present, no coalescing agent is volatilized when the board is passed through the oven. Thus, preferably only water is removed during processing. Because there is no coalescing agent removed, the process produces little or no VOC emissions.

Glass transition temperature (T_{g}) is the temperature at which an amorphous material changes from a brittle vitreous state to a plastic state. Amorphous materials that may have characteristic glass transition temperatures include glasses, polymers, resins, and the like. In the present invention, a T_{g} in the 5-30 C degree range of an amorphous material can be reached at the operating temperatures of the oven (e.g., about 150 degrees F. to about 160 degrees F.). Because the amorphous materials are softened at the temperatures in this range, it is possible to eliminate VOC coalescent material from the coating formulas. In fact, it is contemplated that all components in the application can be selected based on minimal amounts of (or absence of) VOC in the components.

In forming the film, the coating comprises a polymer with a T_{g} of 5-30 C degrees. A coating with a higher T_{g} may be used as a second coat to prevent the boards from sticking together (blocking) or to impart other desirable properties. Alternately, an additional material may be applied via spray to the first coating in its wet or dry state. This is not possible to do with application equipment of the prior art that requires physical contact with the wet coating. For example, in a flood coating applicator of the prior art, brushes and rollers contact the wet coating, so a second material applied to the first wet coating would be mixed into the first coating.

Co-polymers that may be used to form either or both the first and second coatings include acrylic esters having 1 to about 10 carbon atoms such as methyl acrylate, ethyl acrylate, butyl acrylate, 2-ethylhexyl acrylate, decyl acrylate, methyl methacrylate, butyl methacrylate, i-butyl methacrylate, i-bornyl methacrylate, hydroxyethyl acrylate, hydroxyethyl methacrylate, hydroxypropyl methacrylate, phosphoethyl methacrylate, acetoacetoxyethyl methacrylate, N,N dimethylaminoethyl methacrylate, t-butylaminoethyl methacrylate, combinations of the foregoing, and the like. Other polymers that may be used include acrylamide or substituted acrylamides; styrene or substituted styrenes; butadiene; vinyl esters such as vinyl acetate; vinyl ethers; acrylonitrile or methacrylonitrile; combinations of the foregoing; and the like. Also usable are ethylenically-unsaturated carboxylic acids (e.g., methacrylic acid, acrylic acid, itaconic acid, maleic acid, fumaric acid, and the like).

Either polymer (the higher T_{g} polymer or the lower T_{g} polymer) may include a cross-linking agent such as a multi-functional acrylate (e.g., diethylene glycol dimethacrylate, trimethyl propane trimethacrylate, and the like); allyl methacrylate; divinyl benzene; epoxy-, hydroxy-, and carboxy- compounds and the like; combinations of the foregoing; and the like. Preferably, only the higher T_{g} polymer includes a cross-linking agent to avoid compromising the integrity of the film formation.

The polymeric coating compositions may also include dispersing agents therein to provide emulsion qualities. Suitable dispersing agents for use with the polymers include, but are not limited to, dodecyl pyridinium chloride, cetyldimethyl amine acetate, and chloride salts of alkyldimethylbenzylammonium having alkyl groups having from about 8 to about 18 carbon atoms; alkali fatty alcohol sulfates; arylalkyl sulfonates; alkali alkyl sulfosuccinates; alkali arylalkylpolyethoxyethanol sulfates or sulfonates; alkyl phenoxypolyethoxy ethanols having alkyl groups having from about 7 to 18 carbon atoms; ethylene oxide derivatives of long chained carboxylic acids; and long-chained alcohols such as octyl-, decyl-, lauryl-, cetyl alcohols and combinations thereof.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A coating on an architectural building material, said coating comprising:
particles of a first polymer, said particles being made pliable from an initial substantially rigid state via thermal energy;
wherein said first polymer is essentially free of VOC; and
wherein upon application of said first polymer to said architectural building material, said pliable particles form a cohesive film structure on at least an outer surface of said architectural building material upon cooling of said pliable particles of said first polymer.

2. The coating of claim 1, wherein said first polymer has a first glass transition temperature of about 5 C degrees to about 30 C degrees at a temperature of about 150 degrees F. to about 160 degrees F.

3. The coating of claim 1, wherein said first polymer is curable into a film upon cooling.

4. The coating of claim 1, wherein said first polymer is selected from the group consisting of acrylic esters having 1 to about 10 carbon atoms; acrylamides; substituted acrylamides; butadiene; vinyl esters; vinyl ethers; acrylonitrile; methacrylonitrile; ethylenically-unsaturated carboxylic acids; and combinations of the foregoing.

5. The coating of claim 1, further comprising a cross-linking agent.

6. The coating of claim 1, further comprising a dispersing agent.

7. The coating of claim 1, further comprising particles of a second polymer, said particles being made pliable from an initial state via thermal energy, said second polymer having a second glass transition temperature that is greater than said first glass transition temperature;
wherein said second polymer is essentially free of VOC; and
wherein said second polymer is sprayable on said first polymer to form a cohesive film structure on said first polymer upon cooling of said pliable particles of said second polymer.

8. The coating of claim 7, wherein said second polymer is selected from the group consisting of acrylic esters having 1 to about 10 carbon atoms; acrylamides; substituted acrylamides; butadiene; vinyl esters; vinyl ethers; acrylonitrile; methacrylonitrile; ethylenically-unsaturated carboxylic acids; and combinations of the foregoing.

9. The coating of claim 7, further comprising a cross-linking agent.

10. The coating of claim 7, further comprising a dispersing agent.

11. A system for applying coatings on architectural building materials, said system comprising:
a first apparatus for spraying a first polymer emulsion on a building material, said first polymer emulsion being substantially free of VOC;
an apparatus for removing a carrier from said first polymer emulsion and coalescing a first polymer on a surface of said building material;
means for conveying said building material from said first apparatus for spraying said first polymer emulsion to said apparatus for removing water from said first polymer emulsion and coalescing said first polymer.

12. The system of claim 11, further comprising a second apparatus for spraying a second polymer emulsion on said first polymer, said second polymer emulsion being substantially free of VOC.

13. The system of claim 11, wherein said apparatus for removing water comprises a drying station.

14. The system of claim 13, wherein said drying station comprises a flash off zone in which at least a portion of at least one volatile component of said first polymer emulsion is removed.

15. The system of claim 13, wherein said drying station comprises an oven through which air at a temperature of about 110 degrees F. to about 180 degrees F. is forced.

16. The system of claim 15, wherein said oven is substantially enclosed in panels having non-settling mineral wool insulation mounted thereon.

17. The system of claim 13, wherein said drying station comprises a cool down zone from which heat is dissipated from said building material.

18. The system of claim 11, further comprising a closed-loop controller that controls said first apparatus for spraying based on at least one input parameter.

19. The system of claim 18, wherein said at least one input parameter is a speed at which said building material moves through said system.

20. The system of claim 11, further comprising an exhaust system comprising an exhaust fan and a filter, said exhaust system being configured to remove an overspray generated by said first apparatus for spraying.

21. The system of claim 11, wherein said means for conveying said building material from said first apparatus to said apparatus for removing water comprises a first conveyor belt.

22. The system of claim 21, wherein said conveyor includes a transfer station that pushes said building material onto a second conveyor belt extending through said apparatus for removing water.

23. A method of coating an architectural building material, said method comprising the steps of:
providing a building material;
spraying a first emulsion on said building material, said first emulsion comprising particles of a first polymer dispersed in a first carrier;
flashing off at least a portion of said first emulsion, said portion of said first emulsion being substantially free of VOC; and
using heat to coalesce particles of said first polymer on said building material into a first film.

24. The method of claim 23, further comprising the step of spraying a second emulsion on said building material, said second emulsion comprising particles of a second polymer dispersed in a second carrier.

25. The method of claim 24, further comprising the step of flashing off at least a portion of said second emulsion, said portion of said second emulsion being substantially free of VOC.

26. The method of claim 25, further comprising using heat to coalesce the particles of said second polymer on said building material into a second film.

27. The method of claim 23, further comprising cooling said coalesced particles to form said first film.
